(19) United States
(12) Patent Application Publication
(10) Pub. No.: US 2024/0018858 A1
(43) Pub. Date: Jan. 18, 2024

(54) ELECTRIC FRACTURING DRIVETRAIN

(71) Applicant: Caterpillar Inc., Peoria, IL (US)

(72) Inventor: Lucas J. PETERSON, Washington, IL (US)

(73) Assignee: Caterpillar Inc., Peoria, IL (US)

(21) Appl. No.: 17/811,936

(22) Filed: Jul. 12, 2022

(51) Int. Cl. E21B 43/26; F04B 17/03; F04B 49/06

(52) U.S. Cl. CPC E21B 43/2607; F04B 17/03; F04B 49/065

(57) ABSTRACT

In some implementations a drivetrain may include a power source configured to drive a fluid pump. The drivetrain may include the fluid pump. The drivetrain may include a driveshaft configured to transfer power that is output by the power source to the fluid pump. The drivetrain may include a coupling including an elastomeric element, wherein the coupling couples the driveshaft to the power source or to the fluid pump, wherein a rotational stiffness of the elastomeric element is based on one or more resonant frequencies of the drivetrain and an operational speed range of the power source, and wherein the coupling is configured to transfer the power that is output by the power source through the elastomeric element.

### TECHNICAL FIELD

The present disclosure relates generally to hydraulic fracturing systems and, for example, to a drivetrain for an electric fracturing system.

### BACKGROUND

Hydraulic fracturing is a well stimulation technique that typically involves pumping hydraulic fracturing fluid into a wellbore (e.g., using one or more well stimulation pumps) at a rate and a pressure (e.g., up to 15,000 pounds per square inch) sufficient to form fractures in a rock formation surrounding the wellbore. This well stimulation technique often enhances the natural fracturing of a rock formation to increase the permeability of the rock formation, thereby improving recovery of water, oil, natural gas, and/or other fluids.

A hydraulic fracturing system may include one or more power sources for providing power to components (e.g., the fluid pumps) of the hydraulic fracturing system. In some cases, a hydraulic fracturing system may include an electric motor (or other rotational power source) that is configured to drive a fluid pump. In such examples, the hydraulic fracturing system may be referred to as an electric fracturing (eFRAC) system. Because electric fracturing systems may be installed or equipment may be serviced in the field, driveshaft misalignments between a driveshaft of the electric motor and a driveshaft of the fluid pump may occur. These driveshaft misalignments may introduce an excitation into the hydraulic fracturing system.

For example, mechanical resonance may occur when an external source amplifies a vibration level of a mass or structure at the structure's natural frequency. For a rotating mass (e.g., inertia), like an electric motor or a pump, this occurs when excitation frequencies of the electric motor, pump, or other driveline component intersect with one or more torsional modes of the system. The electric motor and load, such as a pump, make up a two-inertia system and may usually be connected by drivetrains, such as driveshafts, gearboxes, belts and/or couplings. A two-inertia system may have at least one frequency where the system tends to oscillate, which may be referred to as a torsional resonant frequency (e.g., a torsional mode). In a hydraulic fracturing driveline torsional system, multiple resonant (e.g., natural) frequencies are possible. Torsional system resonant response, which can occur if any torsional modes intersect with excitation frequencies within a speed range of the electric motor, is typically caused by stiffness and inertia characteristics between the electric motor and the load. For example, each of these driveline components may twist slightly when the motor applies torque. This torque may be increased or modified due to the driveshaft misalignments. This torque may also be increased or modified due to reciprocating pump torque ripple. As a rotational speed of the electric motor causes an excitation frequency to become closer to a resonant frequency of the system, the system may begin to torsionally vibrate. This may result in increased torsional vibration at a natural, or resonant, frequency. As a result, small driveshaft misalignments as well as reciprocating pump excitation of an electric fracturing system may result in increased torsional vibration, which may lead to damage of components of the electric fracturing system and/or a reduced lifespan of the of components of the electric fracturing system, among other examples.

The drivetrain of the present disclosure solves one or more of the problems set forth above and/or other problems in the art.

### SUMMARY

In some implementations, a drivetrain for an electric fracturing system includes a power source configured to drive a fluid pump; the fluid pump; a driveshaft configured to transfer power that is output by the power source to the fluid pump; and a torsionally soft coupling including an elastomeric element, wherein the torsionally soft coupling couples the driveshaft to the power source or to the fluid pump, wherein a rotational stiffness of the elastomeric element is based on one or more resonant frequencies of the drivetrain and an operational speed range of the power source, and wherein the torsionally soft coupling is configured to transfer the power that is output by the power source through the elastomeric element.

In some implementations, a coupling for a drivetrain includes an input element configured to be coupled to an output driveshaft of a power source of the drivetrain, wherein the input element is configured to be rotated via a rotation of the output driveshaft; an elastomeric element coupled to the input element, wherein the elastomeric element is configured to rotate via a rotation of the input element; and an output element configured to be coupled to a cardan driveshaft of the drivetrain, wherein the output element is coupled to the elastomeric element, and wherein the output element is rotated via a rotation of the elastomeric element.

In some implementations, a drivetrain includes a power source configured to drive a fluid pump; the fluid pump; a driveshaft configured to transfer power output by the power source to the fluid pump, wherein the driveshaft is coupled to an input driveshaft of the fluid pump; and a coupling including an elastomeric element, wherein the coupling connects the driveshaft to the power source, wherein a rotational stiffness of the elastomeric element is based on one or more resonant frequencies of the drivetrain and an operational speed range of the power source.

### BRIEF DESCRIPTION OF THE DRAWINGS

FIG. 1 is a diagram illustrating an example hydraulic fracturing system described herein.

FIG. 2 is a diagram of a perspective view of an example drivetrain described herein.

FIG. 3 is a diagram of a cross-section view of the example drivetrain described herein.

FIG. 4 is a resonant speed diagram associated with torsional characteristics of the example drivetrain described herein.

### DETAILED DESCRIPTION

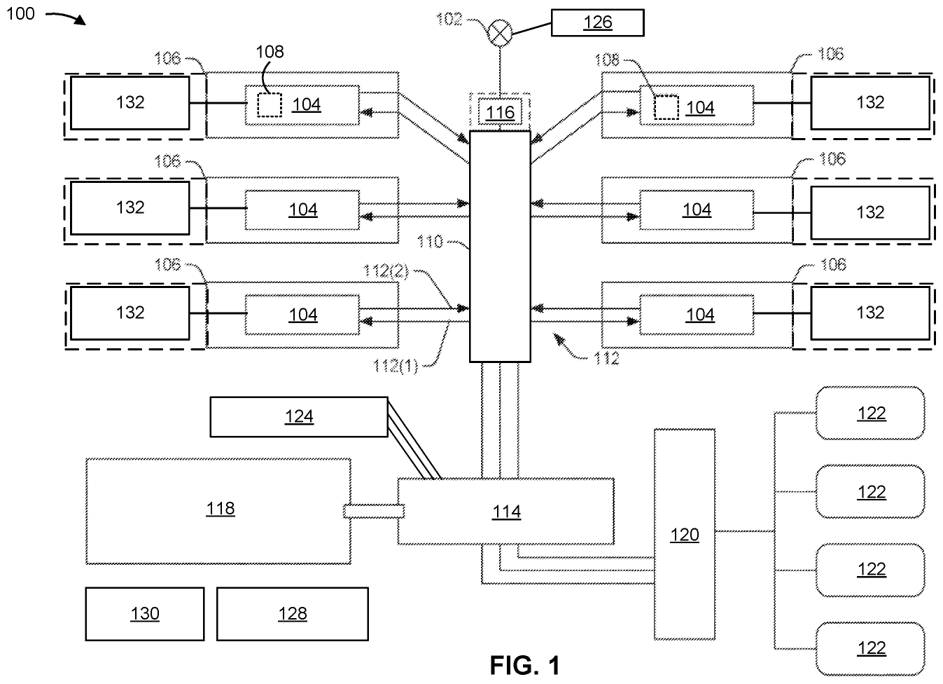

FIG. 1 is a diagram illustrating an example hydraulic fracturing system 100 described herein. For example, FIG. 1 depicts a plan view of an example hydraulic fracturing site along with equipment that is used during a hydraulic fracturing process. In some examples, less equipment, additional equipment, or alternative equipment to the example equipment depicted in FIG. 1 may be used to conduct the hydraulic fracturing process. Although examples may be described herein in connection with the hydraulic fracturing system 100, the drivetrain (sometimes referred to as a driveline or a powertrain, among other examples) described herein (e.g., drivetrain 200) may be used in connection with other systems. For example, the drivetrain described herein (e.g., drivetrain 200) may be used in connection with a system including a power source (e.g., a power source 132) driving a load.

The hydraulic fracturing system 100 includes a well 102. As described previously, hydraulic fracturing is a well-stimulation technique that uses high-pressure injection of fracturing fluid into the well 102 and corresponding wellbore in order to hydraulically fracture a rock formation surrounding the wellbore. While the description provided herein describes hydraulic fracturing in the context of wellbore stimulation for oil and gas production, the description herein is also applicable to other uses of hydraulic fracturing.

High-pressure injection of the fracturing fluid may be achieved by one or more pump systems 104 that may be mounted (or housed) on one or more hydraulic fracturing trailers 106 (which also may be referred to as “hydraulic fracturing rigs”) of the hydraulic fracturing system 100. Each of the pump systems 104 includes at least one fluid pump 108 (referred to herein collectively, as “fluid pumps 108” and individually as “a fluid pump 108”). The fluid pumps 108 may be hydraulic fracturing pumps. The fluid pumps 108 may be positive displacement pumps. The fluid pumps 108 may include various types of high-volume hydraulic fracturing pumps such as triplex or quintuplex pumps. Additionally, or alternatively, the fluid pumps 108 may include other types of reciprocating positive-displacement pumps or gear pumps. A type and/or a configuration of the fluid pumps 108 may vary depending on the fracture gradient of the rock formation that will be hydraulically fractured, the quantity of fluid pumps 108 used in the hydraulic fracturing system 100, the flow rate necessary to complete the hydraulic fracture, and/or the pressure necessary to complete the hydraulic fracture, among other examples. The hydraulic fracturing system 100 may include any number of trailers 106 having fluid pumps 108 thereon in order to pump hydraulic fracturing fluid at a predetermined rate and pressure.

In some examples, the fluid pumps 108 may be in fluid communication with a manifold 110 via various fluid conduits 112, such as flow lines, pipes, or other types of fluid conduits. The manifold 110 combines fracturing fluid received from the fluid pumps 108 prior to injecting the fracturing fluid into the well 102. The manifold 110 also distributes fracturing fluid to the fluid pumps 108 that the manifold 110 receives from a blender 114 of the hydraulic fracturing system 100. In some examples, the various fluids are transferred between the various components of the hydraulic fracturing system 100 via the fluid conduits 112. The fluid conduits 112 include low-pressure fluid conduits 112(1) and high-pressure fluid conduits 112(2). In some examples, the low-pressure fluid conduits 112(1) deliver fracturing fluid from the manifold 110 to the fluid pumps 108, and the high-pressure fluid conduits 112(2) transfer high-pressure fracturing fluid from the fluid pumps 108 to the manifold 110.

The manifold 110 also includes a fracturing head 116. The fracturing head 116 may be included on a same support structure as the manifold 110. The fracturing head 116 receives fracturing fluid from the manifold 110 and delivers the fracturing fluid to the well 102 (via a well head mounted on the well 102) during a hydraulic fracturing process. In some examples, the fracturing head 116 may be fluidly connected to multiple wells 102. The fluid pumps 108, the fluid conduits 112, the manifold 110, and/or the fracturing head 116 may define a fluid system of the hydraulic fracturing system 100.

The blender 114 combines proppant received from a proppant storage unit 118 with fluid received from a hydration unit 120 of the hydraulic fracturing system 100. In some examples, the proppant storage unit 118 may include a dump truck, a truck with a trailer, one or more silos, or other type of containers. The hydration unit 120 receives water from one or more water tanks 122. In some examples, the hydraulic fracturing system 100 may receive water from water pits, water trucks, water lines, and/or any other suitable source of water. The hydration unit 120 may include one or more tanks, pumps, gates, or the like.

The hydration unit 120 may add fluid additives, such as polymers or other chemical additives, to the water. Such additives may increase the viscosity of the fracturing fluid prior to mixing the fluid with proppant in the blender 114. The additives may also modify a pH of the fracturing fluid to an appropriate level for injection into a targeted formation surrounding the wellbore. Additionally, or alternatively, the hydraulic fracturing system 100 may include one or more fluid additive storage units 124 that store fluid additives. The fluid additive storage unit 124 may be in fluid communication with the hydration unit 120 and/or the blender 114 to add fluid additives to the fracturing fluid.

In some examples, the hydraulic fracturing system 100 may include a balancing pump 126. The balancing pump 126 provides balancing of a differential pressure in an annulus of the well 102. The hydraulic fracturing system 100 may include a data monitoring system 128. The data monitoring system 128 may manage and/or monitor the hydraulic fracturing process performed by the hydraulic fracturing system 100 and the equipment used in the process. In some examples, the management and/or monitoring operations may be performed from multiple locations. The data monitoring system 128 may be supported on a van, a truck, or may be otherwise mobile. The data monitoring system 128 may include a display for displaying data for monitoring performance and/or optimizing operation of the hydraulic fracturing system 100. In some examples, the data gathered by the data monitoring system 128 may be sent off-board or off-site for monitoring performance and/or performing calculations relative to the hydraulic fracturing system 100.

The hydraulic fracturing system 100 includes a controller 130. The controller 130 is in communication (e.g., by a wired connection or a wireless connection) with the pump systems 104 of the trailers 106. The controller 130 may also be in communication with other equipment and/or systems of the hydraulic fracturing system 100. The controller 130 may include one or more memories, one or more processors, and/or one or more communication components.

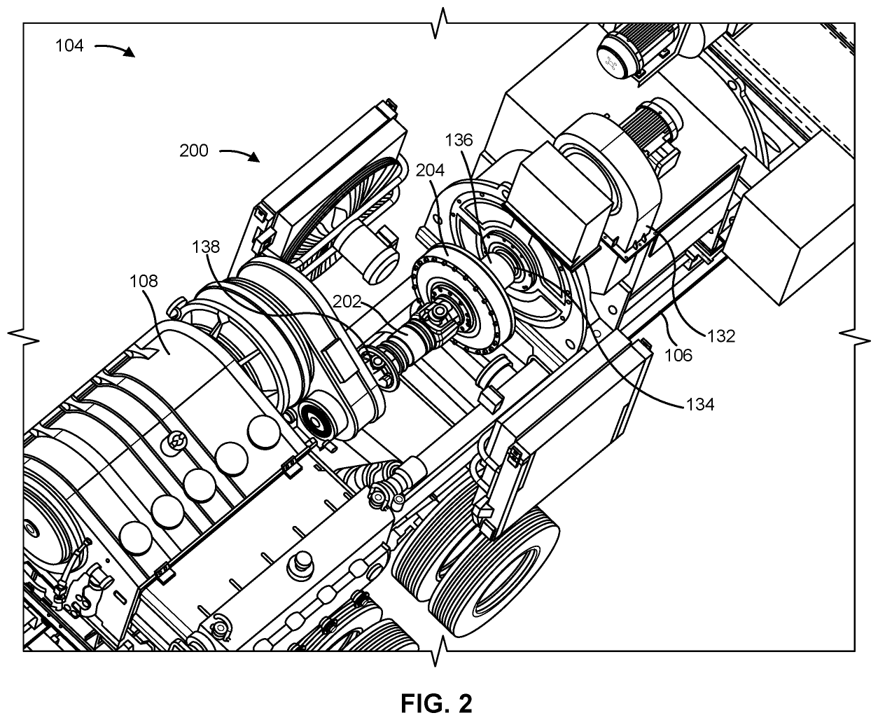

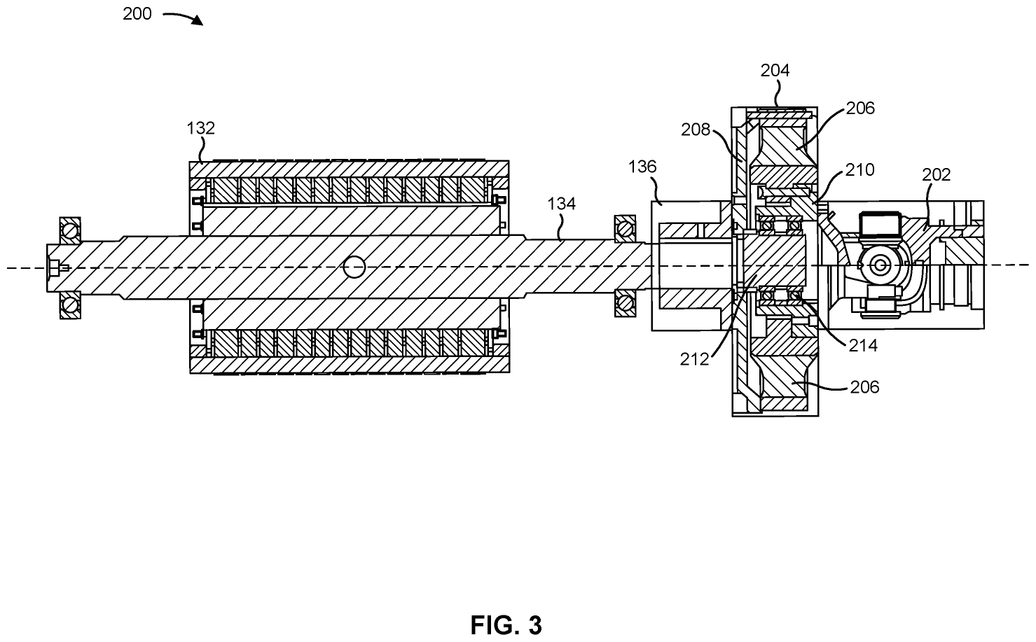

The hydraulic fracturing system 100 may include one or more power sources, such as one or more power sources 132. In some examples, the one or more power sources 132 may include an electric motor (e.g., the hydraulic fracturing system 100 may be an electric fracturing (eFRAC) system). As another example, the one or more power sources 132 may include a motor with gearbox, a turbine, a turbine with gearbox, multiple motors or turbines on a combination gearbox, an engine, and/or another rotational power source (e.g., a power source that causes an output drive shaft to rotate), among other examples. The one or more power sources 132 may be included on a hydraulic fracturing trailers 106 (e.g., as shown by the dashed lines in FIG. 1). Alternatively, a power source 132 may be separate from the hydraulic fracturing trailers 106. In some examples, each pump system 104 may include a power source 132. The power sources 132 may be in communication with the controller 130. The power sources 132 may power the pump systems 104 and/or the fluid pumps 108. A power source 132 may be configured to drive a fluid pump 108 via a drivetrain 200 (e.g., depicted and described in more detail in connection with FIGS. 2 and 3). For example, a power source 132 may be configured to deliver power from the power source 132 to a fluid pump 108 via the drivetrain 200.

As indicated above, FIG. 1 is provided as an example. Other examples may differ from what is described with regard to FIG. 1.

FIG. 2 is a diagram of a perspective view of an example drivetrain 200 described herein. The drivetrain 200 may be configured to transfer power from a power source 132 to a fluid pump 108. In some examples, the drivetrain 200 may be included in a pump system 104 of the hydraulic fracturing system 100.

The drivetrain 200 may include the power source 132. The power source 132 may power or drive the fluid pump 108, as described herein. For example, the power source 132 may be configured to cause an output driveshaft 134, of the power source 132, to rotate at a rotational speed. The output driveshaft 134 may also be referred to as an electric motor drive shaft herein. In some examples, the power source 132 may include a motor hub 136. The motor hub 136 may be a cylindrical element fixed to the output driveshaft 134. For example, the power source 132 may be configured to cause the output driveshaft 134 and the motor hub 136 to rotate at a rotational speed.

The power source 132 may operate over a range of operational speeds (e.g., in units of revolutions per minute (RPMs)). For example, the power source 132 may be associated with an operational speed range. The operational speed range may be a range of rotational speeds at which the electric motor may operate to power or drive the fluid pump 108. For example, the operational speed range may be associated with maximizing an efficiency of the fluid pump 108 and/or the pump system 104. As another example, the operational speed range may be associated with providing a discharge flow of the fluid pump 108 at a given working pressure. The operational speed range of the power source 132 may vary based on a configuration of the pump system 104, a configuration of the power source 132, a configuration of the hydraulic fracturing system 100, and/or an intended discharge flow and pressure of the fluid pump 108, among other examples. In one example, the operational speed range of the power source 132 may be from 2,000 RPMs to 2,500 RPMs.

The drivetrain 200 may include a driveshaft 202. The driveshaft 202 may be configured to transfer power output from the power source 132 to the fluid pump 108. The driveshaft 202 may include universal joints on each end of the driveshaft 202. For example, the driveshaft 202 may be a Cardan driveshaft. For example, the driveshaft 202 may be enabled to transfer power and/or torque output by the power source 132 with an angle between the driveshaft 202 and the output driveshaft 134 of the power source 132 and/or between the driveshaft 202 and an input driveshaft 138 of the fluid pump 108 (e.g., because of the universal joints included on each end of the driveshaft 202). In other words, a first angle between the output driveshaft 134 and the driveshaft 202 may be greater than zero. Additionally, or alternatively, a second angle between the input driveshaft 138 and the driveshaft 202 may be greater than zero. This may provide additional flexibility of the configuration of the drivetrain 200. During initial installation of equipment on the hydraulic fracturing trailer 106, or during service and replacement of equipment, misalignment of the driveshafts may occur.

However, as explained elsewhere herein, this misalignment of the driveshafts may introduce forces and/or excitations into the system that may result in resonant torsional vibrations when the power source 132 is operating at certain speeds. For example, in an ideal scenario, the output driveshaft 134 and the input driveshaft 138 may be parallel, and the cardan driveshaft 202 is at a small angle to both the output driveshaft 134 and input driveshaft 138. However, due to the size of components of the hydraulic fracturing system, installation (e.g., initial installation) done in the field (e.g., under less than ideal conditions), and/or repairs or replacements, among other examples, this ideal scenario may not be possible or feasible. Therefore, there may be some misalignment between the driveshafts of the drivetrain 200 for which one or more components of the drivetrain 200 may compensate, as explained in more detail elsewhere herein. In a system with high torsional stiffness and low damping, there may not enough compliance to absorb induced torsional vibrations from the driveshaft 202, nor enough damping to limit amplitude of torsional resonant responses.

Therefore, the drivetrain 200 may include a coupling 204 (e.g., a torsional coupling). The coupling 204 may be a torsionally soft coupling (which may also be referred to as a torsionally flexible coupling). As used herein, “torsionally soft” may refer to a mechanical characteristic of the coupling 204 associated with reducing torque impulses provided to the coupling 204. For example, a torsionally soft coupling may be configured to absorb torsional shock and/or vibrations, whereas a torsionally stiff coupling may not absorb torsional shock and/or vibrations. For example, a torsionally soft coupling may allow periodic rotational displacement between the fluid pump 108 and the power source 132 from torque ripple without reacting large torque dynamics against the motor. For example, a torsionally soft coupling may allow for some enforced periodic rotational displacement between components (e.g., due to driveshaft misalignment). The coupling 204 may enable the drivetrain 200 to be “tuned” to reduce periodic torsional vibrations caused by an operational speed of the power source 132 and resonant frequencies of the drivetrain 200 (and/or the driveshaft misalignments and/or misalignments of the fluid pump 108), as explained in more detail elsewhere herein.

As shown in FIG. 2, the coupling 204 may be coupled to the power source 132 (e.g., to the output driveshaft 134 and/or the motor hub 136) and the driveshaft 202. In other examples, the coupling 204 may be coupled to the input driveshaft 138 of the fluid pump 108 and the driveshaft 202. In some examples, more than one coupling 204 may be included in the drivetrain 200. For example, a first coupling 204 may be coupled to the power source 132 (e.g., to the output driveshaft 134 and/or the motor hub 136), and the driveshaft 202 and a second coupling 204 may be coupled to the input driveshaft 138 of the fluid pump 108 and the driveshaft 202.

As described in more detail elsewhere herein, the coupling 204 may be configured to transfer a load and/or torque that is input to the coupling 204 directly through the coupling 204 to an output of the coupling 204. For example, in contrast to vibrational dampers (e.g., torsional vibration dampers), flywheels, or similar components (e.g., which may be configured to reduce or absorb torsional vibrations in a system, either by adding or changing an inertia associated with the system, or by using viscous, spring viscous, or spring torsional systems connected to a parallel torsional inertia) a load or torque input to the coupling 204 may be transferred directly through the components of the coupling 204 (e.g., as depicted and described in more detail in connection with FIG. 3). This may provide additional control over the first torsional mode of the drivetrain 200 by changing or “tuning” a stiffness of the coupling 204. As described in more detail elsewhere herein, controlling or tuning the stiffness of the drivetrain 200 may enable the power source 132 to operate over an operational speed range that would have otherwise (e.g., without the coupling 204 tuned to adjust the stiffness of the drivetrain 200) caused harmful torsional vibrations (e.g., that may be caused due to driveshaft misalignments, fluid pump 108 excitation, and/or natural resonant frequencies associated with the drivetrain 200). In other words, the coupling 204 may change the torsional characteristics of the drivetrain 200 so that there is no longer a resonant vibrational response to misaligned driveshaft angles (e.g., over the operational speed range of the power source 132).

As indicated above, FIG. 2 is provided as an example. Other examples may differ from what is described with regard to FIG. 2.

FIG. 3 is a diagram of a cross-section view of the example drivetrain 200 described herein. FIG. 3 shows a partial view of the drivetrain 200 (e.g., not including the full driveshaft 202 and the fluid pump 108). FIG. 3 depicts an example in which the coupling 204 is positioned between the power source 132 and the driveshaft 202. The coupling 204 may be positioned between the driveshaft 202 and the fluid pump 108 in a similar manner as described herein.

The coupling 204 may include an elastomeric element 206. The elastomeric element 206 may be associated with an elastic behavior at a time of loading. For example, the elastomeric element 206 may include an elastomer or a rubber material, among other examples. As used herein, “rubber” may refer to an elastic polymeric substance configured to have elastic characteristics. Some example elastomeric materials include are natural rubber, synthetic rubber, rubber blends, and/or silicone, among other examples. For example, the elastomeric element 206 may be configured to deform or stretch under load (e.g., under shear) and may be capable of recovering size and shape of the elastomeric element 206 after deformation. The elastomeric element 206 may also exhibit high hysteresis during deformation and relaxation due to high torsional damping within the elastomeric material. This torsional damping reduces amplitude of resonant torsional vibration. The elastomeric element 206 may be associated with a rotational stiffness (e.g., in units of kilo Newton meters per radian (kNm/rad)). The rotational stiffness may be a measure of a stiffness of the elastomeric element 206 when the elastomeric element 206 is placed under a rotational shear load. Another example of the coupling 204 with high damping may include tangential compression of a non-metallic material (such as natural rubber, a rubber blend, or silicone, among other examples). These couplings in compression may be referred to as progressive stiffness couplings.

The coupling 204 may include an input element 208. The input element 208 may be an outer hub or an outer ring of the coupling 204. For example, as shown in FIG. 3, the input element 208 have an annular or ring-shaped configuration. The input element 208 may also be referred to as an outer element herein. The input element 208 may extend around other components or elements of the coupling 204, such as the elastomeric element 206. The coupling 204 may include an output element 210. The output element 210 may be an inner hub or inner ring of the coupling 204. For example, as shown in FIG. 3, the output element 210 have an annular or ring-shaped configuration. The output element 210 may also be referred to as an inner element herein. Although described herein using the terms “input” and “output,” a load or power may be input to the coupling 204 via the output element 210 and transferred to the input element 208.

For example, in the configuration shown in FIG. 3, the power source 132 may input power and/or torque to the coupling 204 via the input element 208. The input element 208 may transfer the power and/or torque to the output element 210 through the elastomeric element 206. The output element 210 may transfer the power and/or torque to the driveshaft 202 (e.g., to drive the fluid pump 108). In other configurations, the coupling 204 may be “flipped” such that the power source 132 may input power and/or torque to the coupling 204 via the output element 210. The output element 210 may transfer the power and/or torque to the input element 208 through the elastomeric element 206. The input element 208 may transfer the power and/or torque to the driveshaft 202 (e.g., to drive the fluid pump 108). As another example, power and/or torque may be input to the coupling 204 (e.g., via the input element 208 or the output element 210) from the driveshaft 202. For example, the driveshaft may input power and/or torque to the coupling 204 (e.g., via the input element 208 or the output element 210) and the coupling 204 may transfer the power and/or torque to the input driveshaft 138 of the fluid pump 108 (not shown in FIG. 3).

As shown in FIG. 3, the coupling 204 may be coupled (e.g., mechanically connected) to the power source 132. This may improve load characteristics of the drivetrain 200 by placing the mass of the coupling 204 closer to the power source 132 (e.g., which may be better supported than if the coupling were placed further from the power source 132, such as coupled to the fluid pump 108). For example, the coupling 204 may couple the driveshaft 202 to the power source 132 (or to the fluid pump 108 in other configurations). The input element 208 may be coupled (e.g., mechanically connected) to the output driveshaft 134 (and/or the motor hub 136) of the power source 132 (or to the driveshaft 202 in other configurations). The elastomeric element 206 may be coupled or fixed to the input element 208. For example, elastomeric element 206 may be bonded to an inner surface of the input element 208 (e.g., via an adhesive or other means). The elastomeric element 206 may also engage the input element 208 using a mechanical means, such as coarse teeth among other examples. The output element 210 may be coupled to the driveshaft 202 (e.g., via a universal joint of the driveshaft 202, using a flange, key, or other means of attachment) (or the input driveshaft 138 of the fluid pump 108 in other configurations). The output element 210 may be coupled to the elastomeric element 206. For example, elastomeric element 206 may be bonded or otherwise torsionally engaged to an outer surface of the output element 210 (e.g., via an adhesive or other means).

The coupling 204 may transfer power associated with the rotation of the output driveshaft 134 to the output element 210 through the elastomeric element 206. For example, the output element 210 may be configured to rotate based on a rotation of the input element 208 being transferred to the output element 210 via the elastomeric element 206. For example, the output driveshaft 134 of the power source 132 may rotate at a rotational speed based on power output by the power source 132. The input element 208 may rotate based on the coupling (e.g., mechanical connection) to the output driveshaft 134 (e.g., and/or to the motor hub 136). The rotation of the input element 208 may place the elastomeric element 206 under shear. The elastomeric element 206 may displace and/or twist (e.g., based on the rotational stiffness of the elastomeric element 206). This may cause the elastomeric element 206 to transfer power to the output element 210.

For example, the shear load placed on the elastomeric element 206 may result in the elastomeric element 206 transferring power to the output element 210 causing the output element 210 to rotate. For example, the elastomeric element 206 may be configured to rotate via a rotation of the input element 208, thereby causing a rotation of the output element 210 (e.g., the output element 210 may be rotated via a rotation of the elastomeric element 206). The output element 210 (e.g., the inner element of the coupling 204) may be configured to cause the driveshaft 202 to rotate based on the mechanical connection to the driveshaft 202. All power or load input to the coupling 204 may be transferred from the input element 208, through the elastomeric element 206, and to the output element 210. In other configurations, all power or load input to the coupling 204 may be transferred from the output element 210, through the elastomeric element 206, and to the input element 208 in a similar manner as described above. In other words, all input load (e.g., power and/or torque) to the coupling 204 may be transferred directly through the elastomeric element 206. For example, the drivetrain 200 may be configured to drive the fluid pump 108 by transferring a load (e.g., power and/or torque) output by the power source 132 directly through the coupling 204 and the elastomeric element 206 with negligible power loss. For example, by using an elastic element (e.g., rather than a viscous shear or other continuous slip fluid coupling), a high power transmission efficiency may be achieved (e.g., a power transmission efficiency of >99.96%).

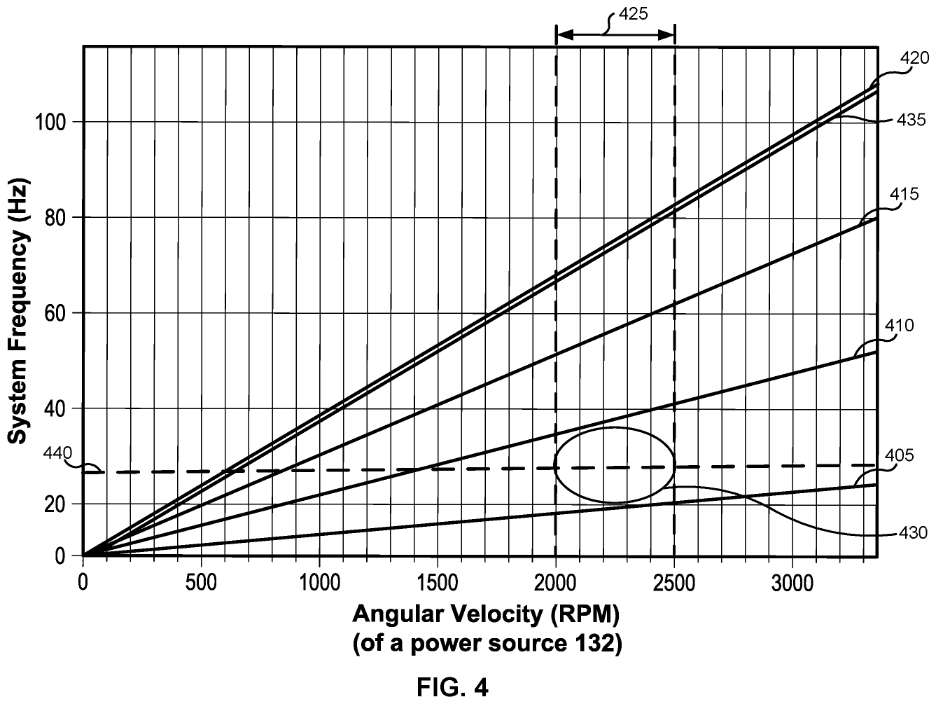

This may provide an additional controllability of the stiffness and first torsional mode of the drivetrain 200 as a whole. For example, as described above, the elastomeric element 206 may be configured to shear and/or deform when placed under load. Because the entire load transferred via the drivetrain 200 passes through the elastomeric element 206, a stiffness and first torsional mode of the drivetrain 200 may be controlled via the rotational stiffness of the elastomeric element 206. For example, the stiffness of the drivetrain 200 may be reduced to a desired level (e.g., that may be selected based on torsional characteristics and/or resonant frequencies of the drivetrain 200, as explained in more detail in connection with FIG. 4) by configuring the elastomeric element 206 to have a given rotational stiffness. As a result, vibrations caused by excitations (e.g., introduced as a result of the driveshaft misalignments and/or pump torque ripple) occurring at resonant (or natural) frequencies of the drivetrain 200 may be avoided at operational speed(s) of the power source 132 by modifying the torsional characteristics of the drivetrain 200 (e.g., by reducing the stiffness of the drivetrain 200 to a desired level, as described herein).

As shown in FIG. 3, the input element 208 (e.g., the outer hub or outer ring) of the coupling 204 may be coupled to the power source 132 (e.g., to the output driveshaft 134 and/or the motor hub 136). Because the input element 208 (e.g., the outer hub or outer ring) may have a larger mass than other components of the coupling 204, such as the output element 210, configuring the coupling 204 in this manner (e.g., with the input element 208 proximate to the power source 132) may improve load distribution characteristics of the drivetrain 200. For example, additional support for the larger mass of the input element 208 may be provided by coupling the input element 208 directly to the power source 132 (e.g., directly to the output driveshaft 134 and/or directly to the motor hub 136). For example, if the coupling 204 were to be “flipped” (e.g., with the output element 210 coupled to the power source 132), the larger mass of the input element 208 may be placed further from the support of the output driveshaft 134 and/or the motor hub 136. This may introduce additional loads and/or strain to the drivetrain 200. Therefore, the additional loads and/or strain may be avoided by coupling the input element 208 (e.g., the outer ring or hub of the coupling 204) directly to the power source 132 (e.g., directly to the output driveshaft 134 and/or directly to the motor hub 136).

In one example, mounting the coupling 204 directly to the motor 132 or to the fluid pump 108, the drivetrain 200 may be simplified (e.g., when compared to an instance where coupling 204 is free-standing). Simplifying the drivetrain 200 in this manner may reduce a cost, reduce a weight, reduce and axial space claim, and/or reduce a quantity of driveline couplings need, among other examples.

The coupling 204 may include a support shaft 212. The support shaft 212 may also be referred to as a stub shaft. The support shaft 212 may be coupled to the input element 208 (e.g., to the outer ring or hub of the coupling 204). The output element 210 may be rotatably coupled to the support shaft 212 via one or more bearings 214. For example, the support shaft 212 may be fixed and mechanically coupled to the input element 208 and/or to another element of the coupling 204. The output element 210 may be supported by the support shaft 212 and be capable of rotating around the support shaft 212 via the one or more bearings 214. The support shaft 212 may provide additional support for the output element 210 (e.g., due to the distance from the support of the output driveshaft 134 and/or the motor hub 136) while also enabling the output element 210 to freely rotate. This support shaft 212 may ensure that the driveshaft 202 remains centered, thereby avoiding vibrations from system rotational imbalance.

As indicated above, FIG. 3 is provided as an example. Other examples may differ from what is described with regard to FIG. 3.

FIG. 4 is a resonant speed diagram associated with torsional characteristics of the example drivetrain 200 described herein. FIG. 4 shows a graph of angular velocity (or rotational speed) of the power source 132 on the horizontal axis (e.g., in units of RPMs) and system frequency on the vertical axis (in units of Hertz (Hz)). The system frequency may also be referred to as a torsional mode or a torsional frequency. A given system frequency may be indicated by a dashed horizontal line on the resonant speed diagram. For example, FIG. 4 depicts a first torsional mode 440 (e.g., at 28 Hz). FIG. 4 depicts a graph showing vibration excitation that can occur at various operating speeds (e.g., angular velocities or rotational speeds) of the power source 132. For example, if an excitation frequency of the drivetrain 200 overlaps with, or intersects with, a resonant frequency (or a natural frequency) of the drivetrain 200 at an operating speed, then resonant response may occur in the drivetrain 200. In systems with low damping, the response amplitude may be high. The graph depicted in FIG. 4 may be referred to as a resonant speed diagram, an interference diagram, or a Campbell diagram, among other examples. Diagonal lines depicted in FIG. 4 are orders of excitation (which vary in frequency based on speed of rotating equipment) and are described herein.

The orders of excitation, operational speed range, and/or system frequencies shown in FIG. 4 are provided as examples. The orders of excitation, operational speed range, and/or system frequencies of the drivetrain 200 may vary based on a configuration of the drivetrain 200, components included in the drivetrain 200, a configuration of the power source 132, and/or a configuration of the fluid pump 108, among other examples. However, a stiffness of the coupling 204 may be tuned or selected in a similar manner as described herein to avoid resonant torsional excitations or orders of excitations and/or vibrations of the drivetrain 200 over a given operating speed range for other orders of excitation, other operational speed ranges, and/or other system frequencies, among other examples.

The system frequency of the drivetrain 200 may be associated with a torsional mode (or torsion mode) of the drivetrain 200. For example, torsional vibrations may be the oscillatory twisting or angular vibration of shafts of the drivetrain 200 that is superimposed to the operating speed. The source of the torsionally vibration of the drivetrain 200 can be externally forced (e.g., due to driveshaft misalignments and/or pump torque ripple) and/or can be an eigenvalue (e.g., a natural frequency of the drivetrain 200). A resonant response may occur if a frequency of the torsional mode (e.g., of the system frequency) coincides with an excitation frequency (e.g., an order of excitation) of the drivetrain 200. Low damped drivelines (e.g., those consisting primarily of steel or other metallic components) may have torsional vibration amplitudes exceeding ten times that of the periodic input excitation (such as a driveshaft misalignment and/or pump torque ripple). Further, in a stiff system, the geometrical excitation due to driveshaft misalignment causes higher torque amplitudes than in a soft (e.g., torsionally soft) system.

As shown in FIG. 4, the drivetrain 200 may be associated with one or more orders of excitation (e.g., orders). Rotating equipment may generate periodic excitation and the frequency of this excitation varies linearly with rotational speed. For example, a first order may be a periodic excitation which occurs once per driveline component revolution. For example, at a component speed of 270 RPM, a first order excitation may be 4.5 Hz (e.g., 270 RPM divided by seconds per minute). There may be higher harmonics (or orders) such as second order, or third order, among other examples. For example, at 270 RPM, a fifth order excitation may be 22.5 Hz (e.g., 270 RPM divided by 60, multiplied by 5 events per revolution). For example, the drivetrain 200 may be associated with an order of excitation 405 (e.g., a fifth order of the fluid pump 108), a second order of excitation 410 (e.g., a tenth order of the fluid pump 108), a third order of excitation 415 (e.g., a fifteenth order of the fluid pump 108), and/or a fourth order of excitation 420 (e.g., a twentieth order of the fluid pump 108), among other examples. The diagonal order lines shown in FIG. 4 may depict excitations associated with the drivetrain 200. For example, the first order of excitation 405 (e.g., a 5^{th} order of the pump 108) may be associated with an excitation that occurs 5 times per revolution of a specific component (e.g., a crankshaft of the fluid pump 108) at different frequencies depending on the rotational speed of the power source 132 (e.g., of the drivetrain 200). In one example, a fluid pump 108 may have an internal gear reduction of 10:1 reducing motor speed down to a crankshaft speed of the fluid pump 108 (e.g., 2,400 RPM motor speed divided by 10 equals 240 RPM).

As shown in FIG. 4, a fifth order excitation 405 of the of 20 Hz may occur at a power source 132 rotational speed of 2,400 RPMs (e.g., 240 RPM crankshaft speed of the fluid pump 108, assuming a gear reduction of 10:1). Therefore, if the system frequency of the drivetrain 200 in an operational mode of the drivetrain 200 were to be 20 Hz, then when the drivetrain 200 is operating at 2,400 RPMs the drivetrain 200 may experience torsional vibrations due to the fifth order excitation intersecting the drivetrain 200 resonant frequency (e.g., due to the resonant or natural frequency of the drivetrain 200 being 20 Hz at an operating speed of 2,400 RPMs). The drivetrain 200 may experience torsional vibrations at other operating speeds due to the other excitations (e.g., other orders of excitation and/or other system frequencies) in a similar manner. As shown in FIG. 4, the horizontal axis refers to a speed of the power source 132 speed, and the diagonal orders of excitation (e.g., based on a crankshaft speed of the fluid pump 108) represent pump torque ripple (such as indicated by reference numbers 405, 410, 415, and/or 420).

As described elsewhere herein, the coupling 204 may be introduced to improve torsional characteristics of the drivetrain 200. For example, the coupling 204 may reduce a stiffness of the drivetrain 200, thereby reducing a system frequency of the drivetrain 200 (e.g., reducing a frequency associated with a torsional mode 440 of the drivetrain 200). An amount by which the system frequency (e.g., the frequency associated with a torsional mode 440 of the drivetrain 200) is reduced may be based on a rotational stiffness of the elastomeric element 206 of the coupling 204. In other words, the system frequency (e.g., the frequency associated with a torsional mode 440 of the drivetrain 200) may be based on the rotational stiffness of the elastomeric element 206 of the coupling 204. As an example, a rotational stiffness of 400 kNm/rad of the elastomeric element 206 may result in a system frequency of 23.7 Hz. As another example, a rotational stiffness of 180 kNm/rad of the elastomeric element 206 may result in a system frequency of 18.7 Hz. As another example, without a coupling 204 in the system, the inertia and stiffness characteristic of the drivetrain 200 may result in a system frequency of 80 Hz.

As shown in FIG. 4, the drivetrain 200 may be associated with an operational speed range 425. As described in more detail elsewhere herein, the operational speed range 425 may be a range of speeds at which the power source 132 may operate to power or drive the fluid pump 108. As an example, the operational speed range 425 of the drivetrain 200 may be between 2,000 RPMs and 2,500 RPMs. To avoid excitations and/or torsional vibrations, the system frequency of the drivetrain 200 should not overlap with an excitation frequency (or an order of excitation) of the drivetrain 200 over the operational speed range 425. For example, as shown by reference number 430, there may be a range of system frequencies that may not overlap with an excitation frequency (or an order of excitation) of the drivetrain 200 over the operational speed range 425. Therefore, if the system frequency (e.g., first torsional mode or natural torsional frequency) of the drivetrain 200 is included in the range of system frequencies, then the drivetrain 200 may not experience excitations and/or torsional vibrations when operating at a rotational speed included in the operational speed range 425. As a result, the drivetrain 200 may be configured to accept some degree of driveshaft misalignments without causing resonant response of torsional vibrations.

The rotational stiffness of the elastomeric element 206 may be based on the one or more excitation frequencies (e.g., orders of excitation) of the drivetrain 200 and the operational speed range 425 of the power source 132 and/or the drivetrain 200. For example, as shown in FIG. 4, the range of system frequencies may be between approximately 21 Hz and approximately 35 Hz. The rotational stiffness of the elastomeric element 206 of the coupling 204 may be selected to result in a system frequency of the drivetrain 200 that is included in the range of system frequencies shown by reference number 430. As an example, the rotational stiffness of the elastomeric element 206 may be from 300 kNm/rad to 500 kNm/rad (e.g., to result in a system frequency of the drivetrain 200 that is included in the range of system frequencies). For example, as shown in FIG. 4, if the system frequency of the drivetrain 200 were to be 40 Hz, then the drivetrain 200 may experience an order of excitation 410 from the fluid pump 108 (e.g., due to the tenth order excitation) when operating at 2,400 RPMs (e.g., which is within the operational speed range 425). However, if the system frequency of the drivetrain 200 were to be 27 Hz, then the drivetrain 200 may not experience an excitation (e.g., due to the tenth order of excitation 410) when operating at 2,400 RPMs because the system frequency does not overlap with an order of excitation of the drivetrain 200 at an operating speed of 2,400 RPMs. In other words, the rotational stiffness of the elastomeric element 206 may result in a frequency associated with a torsional mode of the drivetrain 200 (e.g., a system frequency) not overlapping with the one or more excitation frequencies of the drivetrain 200 over the operational speed range 425 of the power source 132. As a result, the coupling 204 may be configured to enable the drivetrain 200 to operate in between the orders of excitation caused by a torque ripple of the fluid pump 108.

As another example, if the drivetrain 200 is associated with a first torsional mode 440 equal to 27 Hz, a resonant torsional response may be expected when operating at 1620 RPM due to the 10^{th} order excitation 410. In the case of a drivetrain 200 containing a torsionally compliant coupling with low damping characteristics (e.g., a leaf-spring or coil-spring torsional coupling), torsional response amplitude at 1620 RPM may be damaging due to a strong 10^{th} order excitation 410 and a low system damping. As another example, in the case of a drivetrain 200 containing a torsionally compliant coupling with high damping characteristics (e.g., an elastomeric torsional coupling with high hysteresis, such as the coupling 204), torsional response amplitude at 1620 RPM may be damped and limited in amplitude. As a result, the coupling 204 may be configured to enable the drivetrain 200 to operate on orders of excitation caused by a torque ripple of the fluid pump 108.

As shown in FIG. 4, the drivetrain 200 may be associated with a torsional order of excitation 435 (e.g., which results from misalignment of the driveshaft 202). For example, driveshaft misalignment may cause a forced torsional rotation twice per revolution between the power source 132 and the fluid pump 108 (e.g., a second order excitation). As shown in FIG. 4, for a drivetrain 200 operating at 2,400 RPM, the order 435 (e.g., the second order of excitation caused by the driveshaft misalignment) may create a torsional excitation of 80 Hz. In an example where a torsional mode (e.g., resonant frequency) of the drivetrain 200 is 80 Hz, a torsional resonant response may occur at a power source 132 operating speed of 2,400 RPM due to the intersection with order 435 with the system frequency of the drivetrain 200. The coupling 204 may be configured to enable the drivetrain 200 to operate when the input driveshaft 138 of the fluid pump 108 is misaligned with the output driveshaft 134 of the power source 132 (e.g., by shifting the first torsional mode 440 to not coincide with order 435 at an operating speed of 2,400 RPM). As shown in FIG. 4, for example, where the pump internal gear reduction is 10:1, the order 435 may coincide with the 20^{th} order excitation 420 (e.g., caused by a torque ripple of the fluid pump 108). Excitations from order 435 and order 420 are additive, causing higher torsional vibrations. For example, in FIG. 4, a drivetrain 200 with a first torsional mode 40 at 28 Hz is not aligned with the order 435 when operating at 2,400 RPM. As a result, the coupling 204 may be configured to enable the drivetrain 200 to operate without intersecting the first torsional mode 440 with the order 435.

In some examples, the operational speed range 425 of the drivetrain 200 may be selected based on the system frequency of the drivetrain 200. For example, the coupling 204 may be included in the drivetrain 200 to improve the torsional characteristics of the drivetrain 200, as described elsewhere herein. Based on orders of excitation of the drivetrain 200 and the system frequency resulting from the rotational stiffness of the coupling 204, the operational speed range 425 may be selected such that the first torsional mode 440 does not overlap with any excitation orders of the drivetrain 200 over the selected the operational speed range 425.

As indicated above, FIG. 4 is provided as an example. Other examples may differ from what is described with regard to FIG. 4.

### INDUSTRIAL APPLICABILITY

The hydraulic fracturing system 100 may include one or more power sources (e.g., one or more power sources 132) for providing power to components (e.g., the fluid pumps 108) of the hydraulic fracturing system 100. Because electric fracturing systems may be installed or equipment may be serviced in the field, driveshaft misalignments between a driveshaft of the power source 132 and a driveshaft of the fluid pump 108 may occur. These driveshaft misalignments may introduce an excitation into the hydraulic fracturing trailer 106. For example, mechanical resonance may occur when an excitation source amplifies a vibration level of a mass or structure at the structure's natural frequency. For a rotating system, like a power source 132 and a fluid pump 108 connected by a driveshaft 202 (e.g., a cardan driveshaft), excitation occurs at twice per revolution of the driveshaft. Mechanical system resonance, which can occur if any natural frequencies are within a speed range of the power source 132, is typically caused by stiffness characteristics between the electric motor and the load. As a rotational speed of the power source 132 causes an excitation frequency to become closer to a resonant frequency of the system, the system may begin to vibrate. This may result in increased vibration at a natural, or resonant, frequency. As a result, small driveshaft misalignments of an electric hydraulic fracturing trailer 106 may introduce torsional excitations, resulting in increased torsional vibration (e.g., due to low damped resonant response), which may lead to damage of components of the electric fracturing system and/or a reduced lifespan of the of components of the electric hydraulic fracturing trailer 106, among other examples. Failure of any hydraulic fracturing trailer 106 or pump system 104 within the hydraulic fracturing system 100 may result in in-adequate flow to the well 102 and subsequent failure of the well 102.

The drivetrain 200 and/or the coupling 204 described herein enable the drivetrain 200 to operate when the input driveshaft 138 of the fluid pump 108 is misaligned with the output driveshaft 134 of the power source 132. For example, the coupling 204 may be configured such that all power and/or torque that is transferred by the drivetrain 200 (e.g., from the power source 132 to the fluid pump 108) passes through the elastomeric elements 206 of the coupling 204. This may enable a stiffness and/or a system frequency (e.g., a frequency of a torsional mode of the drivetrain 200) to be set at a frequency that does not cause torsional vibrations at an operating speed of the power source 132. For example, frequency associated with a torsional mode of the drivetrain, that is based on the rotational stiffness of the elastomeric element, is not overlapping with one or more orders of excitation (or excitation frequencies) of the drivetrain 200 over an operational speed range of the power source 132. In this way, the power source 132 may operate at rotational speeds included in the operational speed range without causing damaging torsional vibrations in the drivetrain 200 (e.g., that may otherwise be caused due to excitations introduced due to driveshaft misalignments of the drivetrain 200, or that may be caused by a torque ripple of the fluid pump 108). In other words, the drivetrain may include a torsionally soft coupling (e.g., the coupling 204) that absorbs and dampens torsional excitation and vibrations from the fluid pumping driveline system, typically caused by driveshaft misalignment and pump torque ripple. This may reduce damage to components of the drivetrain 200 and/or improve a lifespan of the drivetrain 200 (e.g., due to reducing torsional vibrations in the drivetrain 200 during operation).

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

1. A drivetrain for a fracturing system, comprising:
a power source configured to drive a fluid pump;
the fluid pump;
a driveshaft configured to transfer power that is output by the power source to the fluid pump; and
a torsionally soft coupling including:
an input element coupled to an output driveshaft of the power source or a motor hub of the power source,
an elastomeric element fixed to the input element, and
an output element fixed to the elastomeric element and coupled to the driveshaft,
wherein the output element is configured to rotate based on a rotation of the input element being transferred to the output element via the elastomeric element,
wherein the torsionally soft coupling couples the driveshaft to the power source or to the fluid pump,
wherein a rotational stiffness of the elastomeric element is based on one or more resonant frequencies of the drivetrain and an operational speed range of the power source, and
wherein the torsionally soft coupling is configured to transfer the power that is output by the power source through the elastomeric element.

2. (canceled)

3. The drivetrain of claim 1, wherein a system frequency of the drivetrain, that is based on the rotational stiffness of the elastomeric element, does not overlap with one or more orders of excitation of the drivetrain over the operational speed range of the power source.

4. The drivetrain of claim 1, wherein the driveshaft includes universal joints on each end of the driveshaft.

5. The drivetrain of claim 1,
wherein the fluid pump includes an input driveshaft, and
wherein at least one of:
a first angle between the output driveshaft and the driveshaft is greater than zero, or
a second angle between the input driveshaft and the driveshaft is greater than zero.

6. The drivetrain of claim 1, wherein the elastomeric element includes a natural rubber, synthetic rubber, blended rubber, or silicone material.

7. A coupling for a drivetrain, comprising:
an input element configured to be coupled to an output driveshaft of a power source of the drivetrain,
wherein the input element is configured to be rotated via a rotation of the output driveshaft;
an elastomeric element coupled to the input element,
wherein the elastomeric element is configured to rotate via a rotation of the input element, and
wherein a rotational stiffness of the elastomeric element is based on an operational speed of the power source; and
an output element configured to be coupled to the elastomeric element and a cardan driveshaft of the drivetrain,
wherein the output element is configured to rotate via the rotation of the input element being transferred to the output element via rotational shear of the elastomeric element.

8. The coupling of claim 7, wherein the coupling transfers power associated with the rotation of the output driveshaft to the output element through the elastomeric element.

9. The coupling of claim 7, further comprising:
a support shaft coupled to the input element, wherein the output element is rotatably coupled to the support shaft via one or more bearings.

10. The coupling of claim 7, wherein the rotational stiffness is further based on one or more torsional characteristics of the drivetrain.

11. The coupling of claim 10, wherein the one or more torsional characteristics of the drivetrain include one or more resonant frequencies of the drivetrain.

12. The coupling of claim 7, wherein the operating speed is from 2,000 revolutions per minute (RPMs) to 2,500 RPMs, and wherein the rotational stiffness is from 240 kilo Newton meters per radian (kNm/rad) to 500 kNm/rad.

13. The coupling of claim 7, wherein the input element is an outer hub of the coupling and the output element is an inner hub of the coupling.

14. The coupling of claim 7, wherein the input element is an inner hub of the coupling and the output element is an outer hub of the coupling.

15. A drivetrain, comprising:
a power source configured to drive a fluid pump;
the fluid pump;
a driveshaft configured to transfer power output by the power source to the fluid pump,
wherein the driveshaft is coupled to an input driveshaft of the fluid pump; and
a coupling including:
an input element coupled to an output driveshaft of the power source or a motor hub of the power source,
an elastomeric element coupled to the input element,
wherein the elastomeric element is an annular elastomeric element, and
an output element coupled to the elastomeric element and the driveshaft,
wherein the output element is configured to rotate based on a rotation of the input element being transferred to the output element via the elastomeric element,
wherein the coupling connects the driveshaft to the power source, and
wherein a rotational stiffness of the elastomeric element is based on one or more resonant frequencies of the drivetrain and an operational speed range of the power source.

16. The drivetrain of claim 15, wherein the power source includes at least one of an electric motor, a turbine, a gearbox, or a combination thereof.

17. The drivetrain of claim 15, wherein the coupling is a torsionally soft coupling.

18. The drivetrain of claim 15, wherein the coupling is configured to enable the drivetrain to operate when a system frequency of the drivetrain aligns with an excitation order of the fluid pump in the operational speed range by damping the system frequency.

19. The drivetrain of claim 15, wherein a frequency associated with a torsional mode of the drivetrain, that is based on the rotational stiffness of the elastomeric element, is not overlapping with one or more orders of excitation of the drivetrain over the operational speed range of the power source.

20. The drivetrain of claim 15, wherein the coupling is configured to enable the drivetrain to operate when the input driveshaft of the fluid pump is misaligned with the output driveshaft of the power source.

21. The drivetrain of claim 1,
wherein the operational speed range comprises a range that is within 2,000 revolutions per minute (RPMs) to 2,500 RPMs, and
wherein the rotational stiffness is 180 kilo Newton meters per radian (kNm/rad) to 500 kNm/rad.
